(19) United States
(12) Patent Application Publication
(10) Pub. No.: US 2017/0089405 A1
(43) Pub. Date: Mar. 30, 2017

(54) SYNCHRONIZED WEDGE CLUTCH WITH DETENT

(71) Applicant: SCHAEFFLER TECHNOLOGIES AG & CO. KG, HERZOGENAURACH (DE)

(72) Inventors: BRIAN LEE, YORK, SC (US); CARSTEN OHR, CHARLOTTE, NC (US)

(21) Appl. No.: 15/254,311

(22) Filed: Sep. 1, 2016

Related U.S. Application Data
(63) Continuation-in-part of application No. 14/871,003, filed on Sep. 30, 2015.

(51) Int. Cl. F16D 15/00; F16D 43/20; F16D 23/02

(52) U.S. Cl. CPC F16D 15/00; F16D 23/02; F16D 43/20

(57) ABSTRACT

A wedge clutch, including an outer carrier, a first clutch plate non-rotatably connected to the outer carrier, a wedge clutch plate, a hub radially inward of the outer carrier, an engagement assembly including a pin with a curved contact surface portion partially disposed within the hub and contacting the wedge clutch plate. For a first synchronization stage for engaging the wedge clutch, an actuator is arranged to clamp the first clutch plate and the wedge clutch plate, and a contact portion of the pin extending radially outward beyond an outer circumference of the hub is arranged to transmit torque between the hub and the wedge plate. For a second synchronization stage for engaging the wedge clutch, the hub and the wedge clutch plate are arranged to circumferentially displace with respect to each other; and the wedge clutch plate is arranged to displace the pin radially inward.

### CROSS REFERENCE TO RELATED APPLICATIONS

This is a continuation-in-part of U.S. patent application Ser. No. 14/871,003 filed Sep. 30, 2015, incorporated herein by reference.

### TECHNICAL FIELD

The present disclosure relates generally to a wedge clutch using a combination of clutch plates and wedge clutch plates.

### BACKGROUND

FIG. 12 is an exploded view of prior art wedge clutch 210. Clutch 210 includes carrier 212, clutch plates 214, wedge clutch plates 216, hub 218, pins 220, plate 222 and plate 224. Pins 220 pass through openings 226 in plates 214 and 216 and are connected to plates 222 and 224 via openings 228 and 230, respectively. Each of pins 220 includes a portion 220A and a portion 220B. The outside diameter of each portion 220A is less than the outside diameter of each portion 220B. Plates 214 are non-rotatably connected to carrier 212 via protrusions 232 in slots 234 in carrier 212. Plates 222 and 224 are non-rotatably connected to hub 218. Plates 216 include ramps 236 extending radially inward along circumferential direction CD1. Hub 218 includes ramps 238 extending radially outward in circumferential direction CD2 opposite direction CD1.

For a first synchronization stage, a first actuator (not shown) displaces pins 220 such that portions 220B are disposed in openings 226. The outer diameter of portions 220B is such that portions 220B essentially fill openings 226 and prevent rotation of plates 216 with respect to hub 218. A second actuator (not shown) clamps plates 214 and 216 such that torque received by hub 218, for example, is transmitted to carrier 212 via plates 214 and 216.

For a second synchronization stage, the first actuator displaces the pins such that portions 220A are disposed in openings 226 and the second actuator is de-activated to enable rotation between plates 216 and hub 218. Due to the smaller outer diameter of portions 220A: pins 220 are able to rotate in openings 226; plates 216 and hub 218 are able to rotate with respect to each other; and ramps 236 and 238 slide along each other to displace plates 216 radially outward. The radially outward displacement of plates 216 non-rotatably connects carrier 212 and hub 218.

The use of two actuators increases the cost, complexity, size, and energy requirements of clutch 210 and reduces the robustness and reliability of clutch 210.

### SUMMARY

The present disclosure broadly describes a wedge clutch using a combination of clutch plates and wedge clutch plates, preferably, but not essentially, a single actuator, and pins in a hub, which pins are bised toward the wedge clutch with a spring or a resilient material such as a rubber or a polymeric foam. In particular, the pins are used to non-rotatably connect the hub and the wedge clutch plate in a first stage for engaging the clutch and to enable relative rotation between the hub and the wedge clutch plates to expand the wedge clutch plate for a second stage for engaging the clutch. In more detail, a wedge clutch rotatable about a rotational axis is disclosed including: an outer carrier; a first clutch plate non-rotatably connected to and axially movable relative to the outer carrier; a wedge clutch plate between the outer carrier and the first clutch plate; a hub at least partially radially inward of all of the outer carrier, first clutch plate; an engagement assembly including a pin partially disposed within the hub and biased to be in contact with the wedge clutch plate; and preferably an actuator for axially moving the first clutch plate relative to the outer carrier and wedge clutch plate. For a first synchronization stage for engaging the wedge clutch: the actuator is arranged to clamp the first clutch plate and the wedge clutch plate; and a contact portion of the pin extending radially outward beyond an outer circumference of the hub is arranged to transmit torque between the hub and the wedge clutch plate. For a second synchronization stage for engaging the wedge clutch: the hub or the wedge clutch plate are arranged to circumferentially displace with respect to each other; and the wedge clutch plate is arranged to displace the pin radially inward permitting the hub, having a non-circular circumferential surface, to turn and engage with ramps in the wedge plate about a non-circular central area through which the hub passes such that turning of the hub relative to the wedge plate expands the wedge plate so the outer circumferential surface of the wedge plate locks with an internal circumferential surface of the carrier. In the description herein, the term “circumference” is intended to denote a circumferential surface of the component being described.

The present disclosure broadly describes a wedge clutch, including: an outer carrier; a first clutch plate non-rotatably connected to the outer carrier; a wedge clutch plate; a hub radially inward of the outer carrier and wedge clutch plate. The outer carrier, first clutch plate, wedge clutch plate and hub are arranged to be rotatable about a common axis of rotation. An engagement assembly is provided including a pin non-rotatably connected to the hub and engageable with the wedge clutch plate and, for a first synchronization stage, engaging the wedge clutch by forcing engagement between the first clutch plate and the wedge clutch plate, preferably by using an actuator. During the first synchronization stage, the pin is arranged to non-rotatably connect the hub and the wedge clutch plate. For a second synchronization stage for engaging the wedge clutch, a difference in torque between the wedge clutch plate and hub applies a first force urging the pin radially inward into the hub permitting a difference in degree of rotation between the hub and wedge clutch plate expanding the wedge clutch plate to engage with the carrier.

The wedge clutch plate preferably includes a notch in an inner circumference of the wedge clutch plate, and the hub includes a slot, An engagement assembly is thus provided including the pin having at least a portion disposed in the slot, and a resilient element is disposed in the slot urging the pin radially outward. The actuator, when present, is arranged to engage the wedge clutch by clamping the first clutch plate and the wedge clutch plate, in a first synchronization stage so that the first clutch plate and the wedge clutch plate transmit torque between the hub and the carrier. For the first synchronization stage, the pin is disposed in the notch to non-rotatably connect the hub and the wedge clutch plate. For a second synchronization stage for engaging the wedge clutch the wedge plate is arranged to apply a force, in a circumferential direction, to a portion of the pin radially outward of the outer circumference for the hub, the force is arranged to displace the pin radially inward, and, as the pin displaces radially inward, the wedge clutch plate is arranged to circumferentially displace with respect to the hub to expand the wedge clutch plate to non-rotatably connect to the hub and the carrier.

### BRIEF DESCRIPTION OF THE DRAWINGS

The nature and mode of operation of the present disclosure will now be more fully described in the following detailed description of the present disclosure taken with the accompanying figures, in which:

FIG. 1 is a perspective view of a cylindrical coordinate system demonstrating spatial terminology used in the present application;

FIG. 2 is a schematic/block diagram of an embodiment of the disclosure of a wedge clutch 100 showing expanded arrangements of the carrier 102, the first clutch plate 104, the wedge plate 106, the hub 108 and an actuator 114;

FIG. 3 is an expanded perspective view of an embodiment of a web clutch of the disclosure;

FIG. 4 is a cut-away front view of an embodiment of wedge clutch 100 showing cylindrical axially parallel torsion pins 110A engaged with wedge clutch plate 106;

FIG. 5 is a magnified view of a pin assembly 110 engaged with wedge clutch plate 106 as shown in Section 5 of FIG. 4;

FIG. 6 is a cut-away front view of an embodiment of wedge clutch 100 showing torsion pins 110A disengaged with wedge clutch plate 106;

FIG. 7 is a magnified view of an embodiment of a pin assembly 110 disengaged with wedge clutch plate 106 as shown in Section 7 of FIG. 6;

FIG. 8 is an elevational cross sectional view of an embodiment of an assembled wedge clutch embodiment of the disclosure showing pin 110A engaged with wedge clutch plate 106;

FIG. 9 is an elevational cross sectional view of an embodiment of an assembled wedge clutch embodiment of the disclosure showing pin 110A disengaged with wedge clutch plate 106;

FIG. 10 shows an analysis of force vectors on a pin 110A according to an embodiment of the disclosure;

FIG. 11 shows a side cross sectional elevational plan view of an expanded wedge clutch of the disclosure having a plurality of clutch plates 104 alternating with a plurality of wedge plates 106;

FIG. 12 shows a prior art wedge clutch that requires multiple actuators.

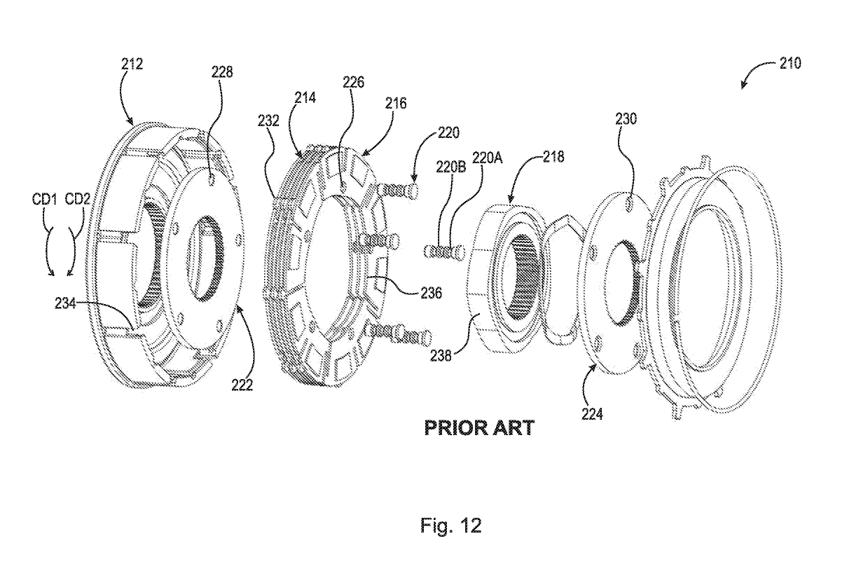

### DETAILED DESCRIPTION

At the outset, it should be appreciated that like drawing numbers on different drawing views identify identical, or functionally similar, structural elements of the disclosure. It is to be understood that the disclosure as claimed is not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should also be understood that any methods, devices or materials similar or equivalent to those described herein can be used in the practice or testing of the disclosure.

Unless defined otherwise, all technical and scientific terms used herein have the same meaning as commonly understood to one of ordinary skill in the art to which this present disclosure belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims. “Curvilinear” means any open or closed combination of straight or curved lines or both. “Cylindrical”, as used herein, is used in its broad mathematical sense, and includes, i.e., prismatic type structures having a central axis and an external sidewall surface or surfaces at least approximately parallel to the central axis. Frustoconical or frustotrapezoidal sidewall configurations may be permitted but usually should not have external surface sidewalls that deviate from being parallel to the central axis by more than ten degrees. The configuration of a cross section in a plane perpendicular to the central axis of the cylinder may be circular, elliptical, polygonal or of any other curvilinear shape suitable for use in accordance with the requirements of wedge clutch described herein. When reference to a cylinder with a particular cross section is intended, “cylinder” will be modified by the cross sectional configuration, e.g., “circular cylinder” or “elliptical cylinder”, will be used. A particularly preferred cross section has four sides, three of which are straight lines and one of which is convexly arcuate to form a contact portion of the pin for contacting the wedge clutch plate.

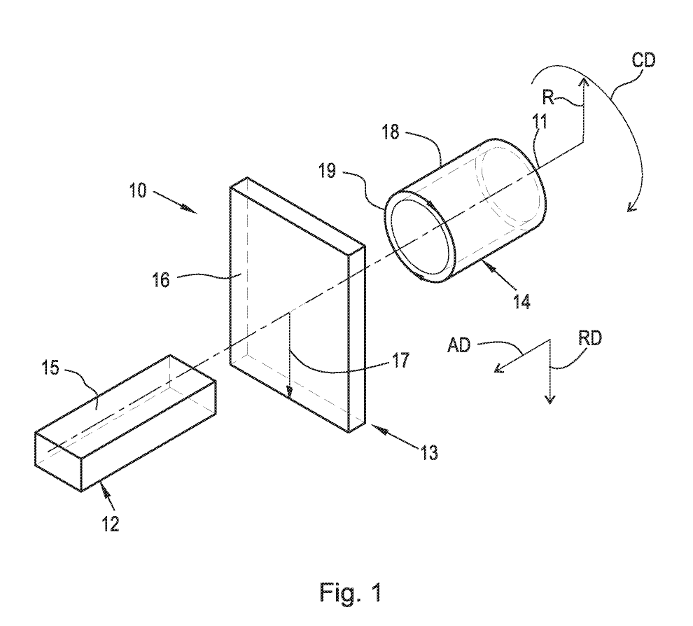

FIG. 1 is a perspective view of cylindrical coordinate system 10 demonstrating spatial terminology used in the present application. The present application is at least partially described within the context of a cylindrical coordinate system. System 10 includes longitudinal axis 11, used as the reference for the directional and spatial terms that follow. Axial direction AD is parallel to axis 11. Radial direction RD is orthogonal to axis 11. Circumferential direction CD is defined by an endpoint of radius R (orthogonal to axis 11) rotated about axis 11.

To clarify the spatial terminology, objects 12, 13, and 14 are used. An axial surface, such as surface 15 of object 12, is formed by a plane co-planar with axis 11. Axis 11 passes through planar surface 15; however any planar surface co-planar with axis 11 is an axial surface. A radial surface, such as surface 16 of object 13, is formed by a plane orthogonal to axis 11 and co-planar with a radius, for example, radius 17. Radius 17 passes through planar surface 16; however any planar surface co-planar with radius 17 is a radial surface. Surface 18 of object 14 forms a circumferential, or cylindrical, surface. For example, circumference 19 is passes through surface 18. As a further example, axial movement is parallel to axis 11, radial movement is orthogonal to axis 11, and circumferential movement is parallel to circumference 19. Rotational movement is with respect to axis 11. The adverbs “axially,” “radially,” and “circumferentially” refer to orientations parallel to axis 11, radius 17, and circumference 19, respectively. For example, an axially disposed surface or edge extends in direction AD, a radially disposed surface or edge extends in direction R, and a circumferentially disposed surface or edge extends in direction CD.

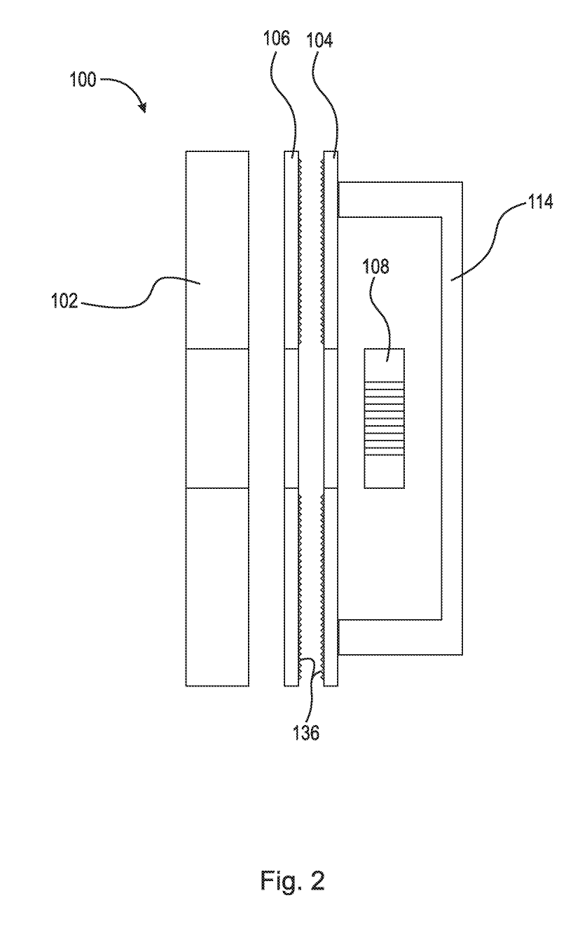

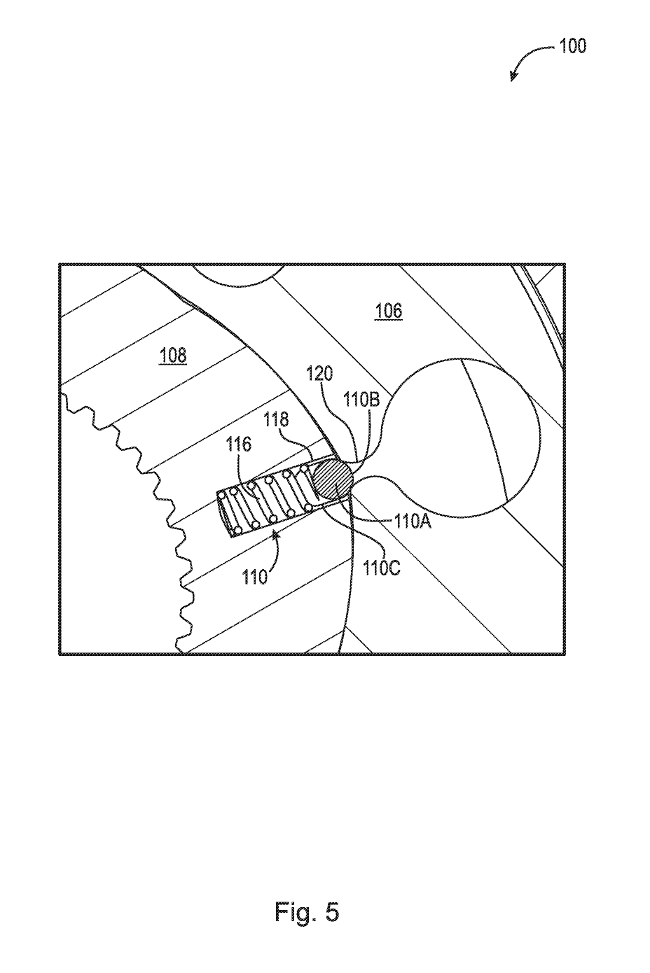

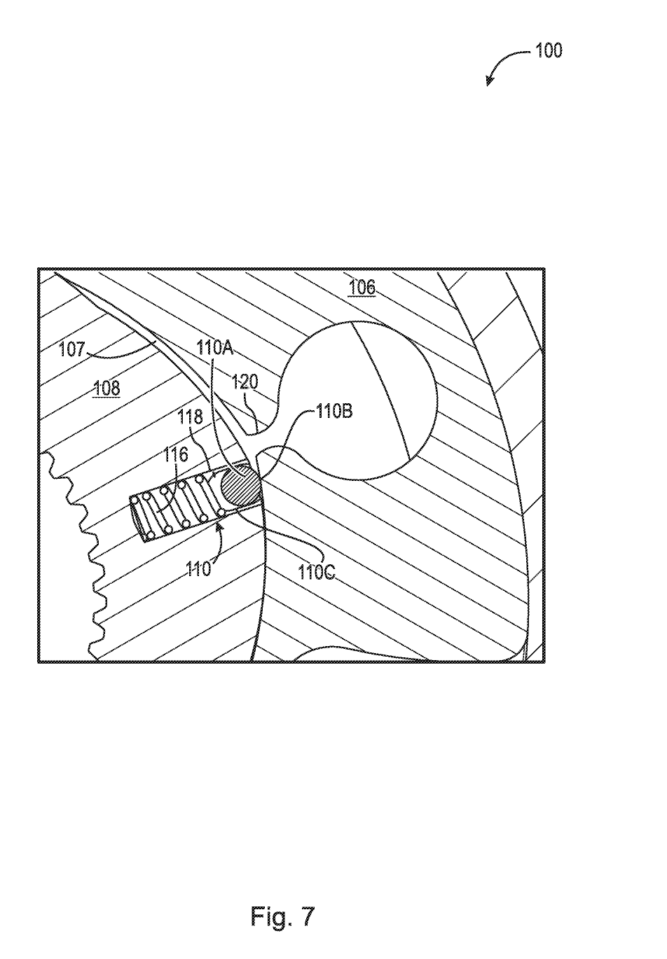

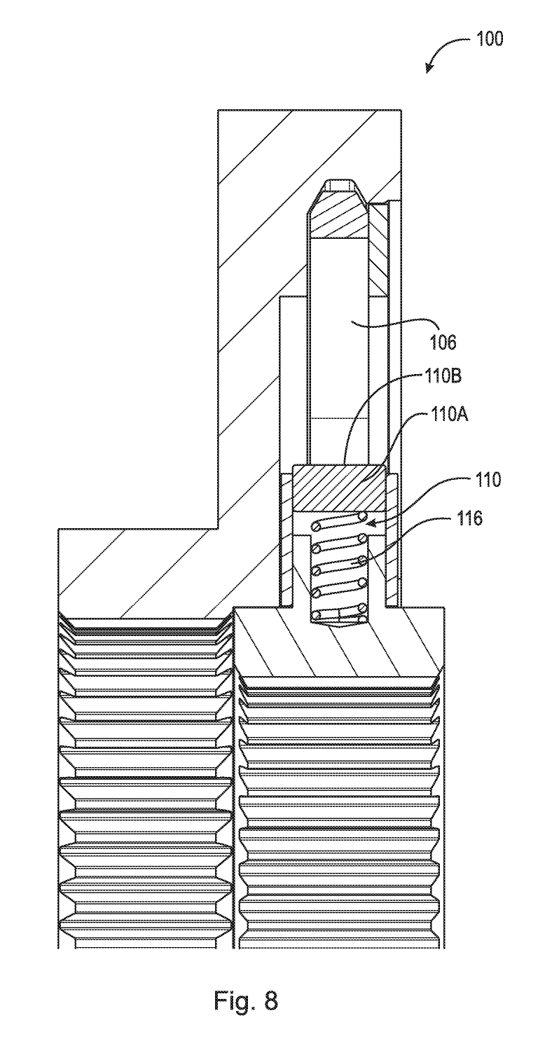

The following should be viewed in light of FIGS. 2 through 11.

Wedge clutch 100, rotatable about axis of rotation AR, includes outer carrier 102; at least one clutch plate 104 connected to and non-rotatable with respect to outer carrier 102; at least one wedge clutch plate 106; a hub 108 radially inward of outer carrier 102; and an engagement assembly 110. Clutch plate 104 and wedge plate 106 are radially disposed between carrier 102 and hub 108. Outer carrier 102 accommodates wedge plate 106, clutch plate 104 and hub 108. When actuator 114 applies force F5 to clutch plate 104 in a direction parallel to central axis of rotation AR, rotation of hub 108 is initiated relative to wedge clutch plate 106. Hub 108 has a variable radius forming hub ramps 134 such that it engages wedge clutch plate ramps 132 in a central portion WOC of wedge plate 106 to radially expand and engage at the circumference of wedge plate 106 with an inner circumference CIC of outer carrier 102 thus locking hub 108 to carrier 102 to engage clutch 100.

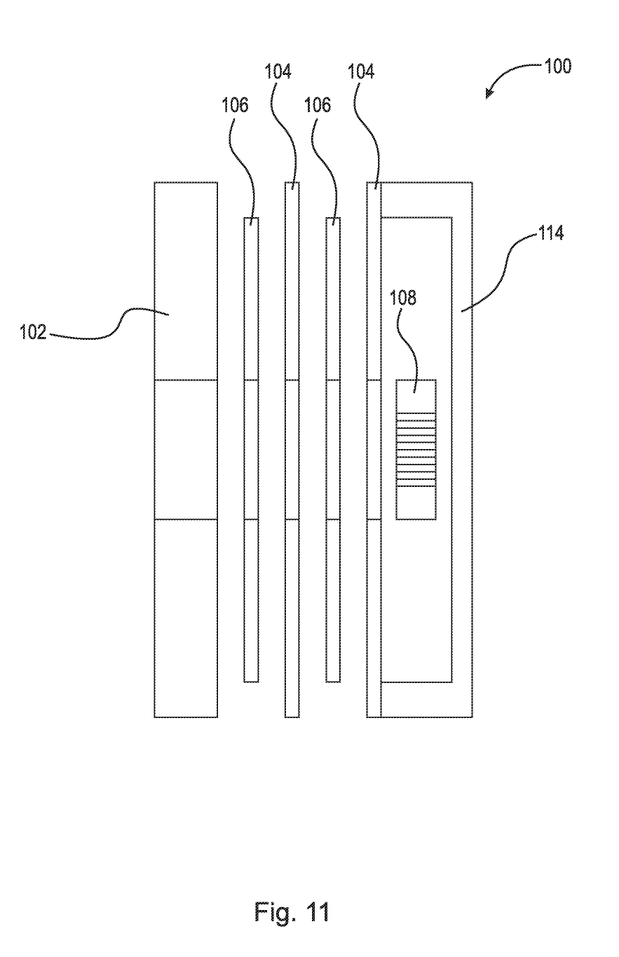

In an example embodiment, e.g., as shown in FIG. 11, clutch 100 may include pluralities of alternating plates 104 and 106; however, for ease of understanding, the discussion that follows is directed to a less complicated embodiment having single plates 104 and 106, unless noted otherwise.

By “non-rotatably” connected elements we mean: when any one of the elements rotate, the other elements rotate as well; and relative rotation between the non-rotatably connected elements is not possible. That is, the connected elements are essentially a monolithic structure with respect to rotation. Although a particular number and ratio of plates 104 and 106 are shown in the example embodiments of FIGS. 2 through 10, it should be understood that other numbers and ratios of plates 104 and 106 are possible, e.g., as shown in FIG. 11.

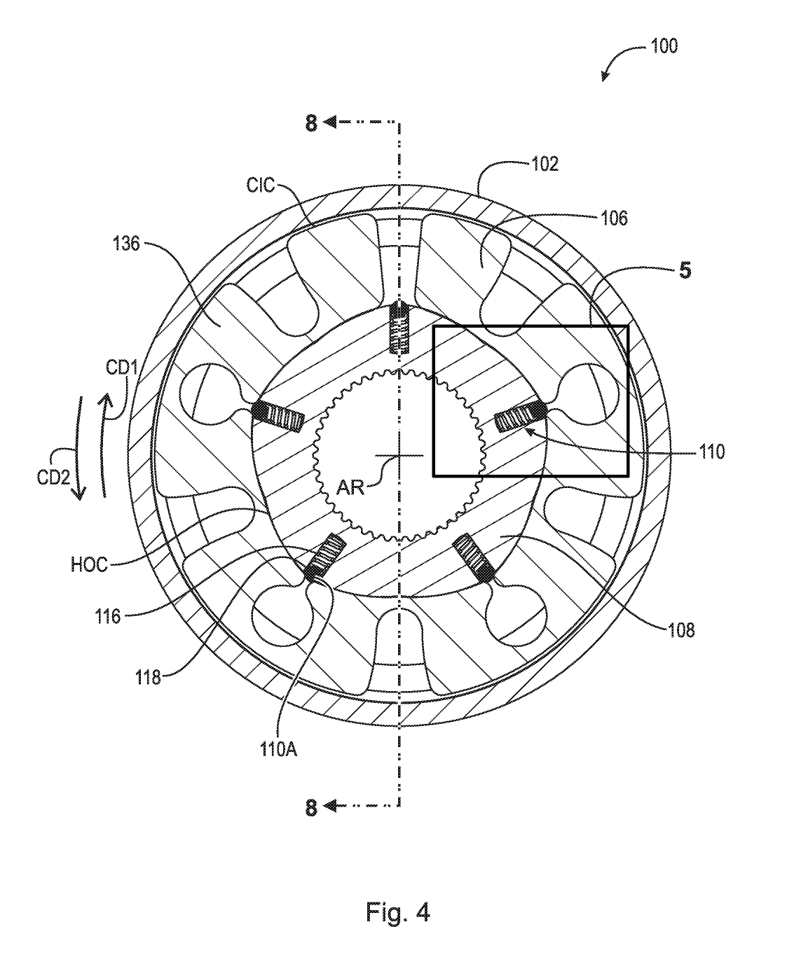

In FIG. 4, clutch plate 104 has been cut-away radially inward of inner circumference CIC of carrier 102 in order to show wedge clutch plate 106.

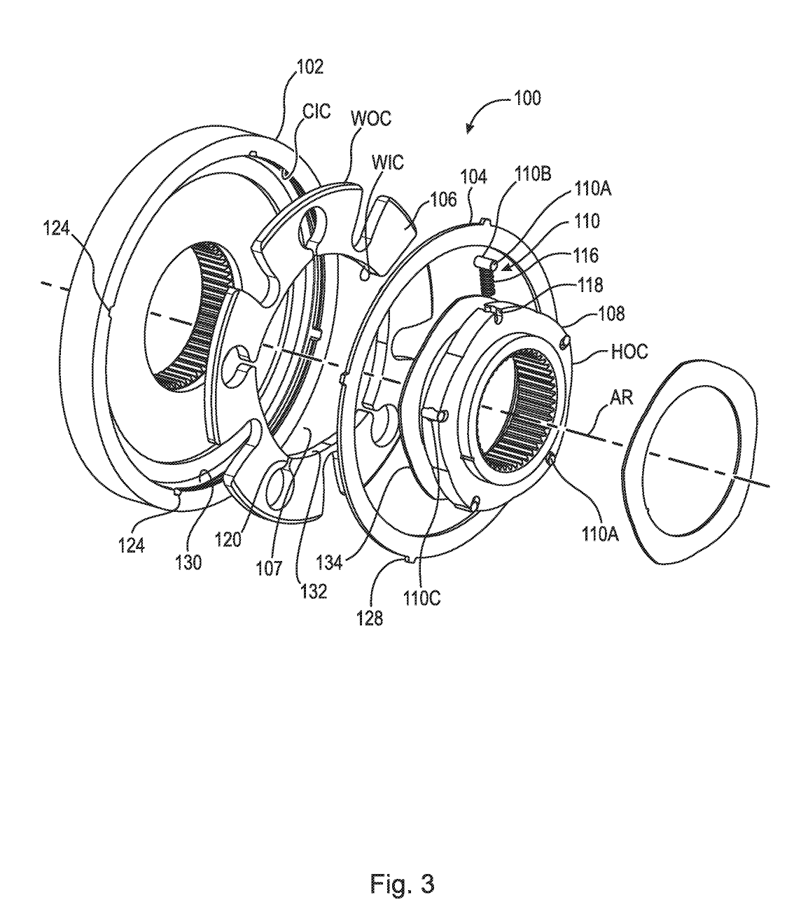

Assembly 110 includes pin 110A partially disposed within hub 108 and in contact with wedge clutch plate 106. In an example embodiment, as seen in FIGS. 2 and 3, clutch 100 includes actuator 114. For a first synchronization stage for engaging the wedge clutch, actuator 114 is arranged to clamp clutch plate 104 and wedge clutch plate 106. Respective contact portions 110B of pins 110A, extending radially outward beyond outer circumference HOC of hub 108, are arranged to transmit torque between hub 108 and outer carrier 102. By “clamping” we mean axially compressing and frictionally engaging clutch plates 104 and wedge clutch plates 106 so that torque, transmitted by one of hub 108 or outer carrier 102, is transmitted through clamped clutch plates 104 and wedge clutch plates 106 to the other of hub 108 or outer carrier 102. Although actuator 114 is shown engaging plates 104 in FIG. 2 it should be understood that the actuator could engage plates 106 to accomplish the clamping function. That is, regardless of which plate is actually contacted by the actuator, plates 104 and 106 are clamped.

Although a particular number and configuration of pins 110A are shown in the example of FIG. 3, it should be understood that other numbers and configurations of pins 110A are possible. In particular, the contact portion 110B of pin 110A preferably has a convexly curved surface to permit it to be forced into hub 108 by rotation of wedge clutch plate 106. The curve on surface 110B is usually a part of an ellipse, parabola or hyperbola and is usually oriented so that the convex curve of the surface can be clearly seen in a cross section in a plane perpendicular to the rotational axis of hub 108. The curve permits easier and gradual movement into hub 108 by relative motion of wedge clutch plate 106 with respect to hub 108. Actuator 114 can be any actuator known in the art. In an example embodiment, actuator 114 is a pancake solenoid actuator, but may be, for example, a piston of a hydraulic cylinder or a linear acting arm from a cam. It should be understood that it is possible to clamp plates 104 and 106 by mechanisms other than an automatic actuator, e.g., by a manually operated mechanism.

For a first synchronization stage, e.g., as seen in FIG. 4, hub 108 is arranged to transmit force, in circumferential direction CD1, to wedge clutch plates 106 through pin contact portions 110B of pins 110A; or, wedge clutch plates 106 are arranged to transmit force, in a circumferential direction CD1, to hub 108 through contact portions 110B of pins 110A. Direction CD1 is based upon hub 108 or outer carrier 102 receiving torque in direction CD1. It should be understood that the discussion above and below applies to the case in which hub 108 or outer carrier 102 receives torque in direction CD2, with direction CD2 taking the place of direction CD1.

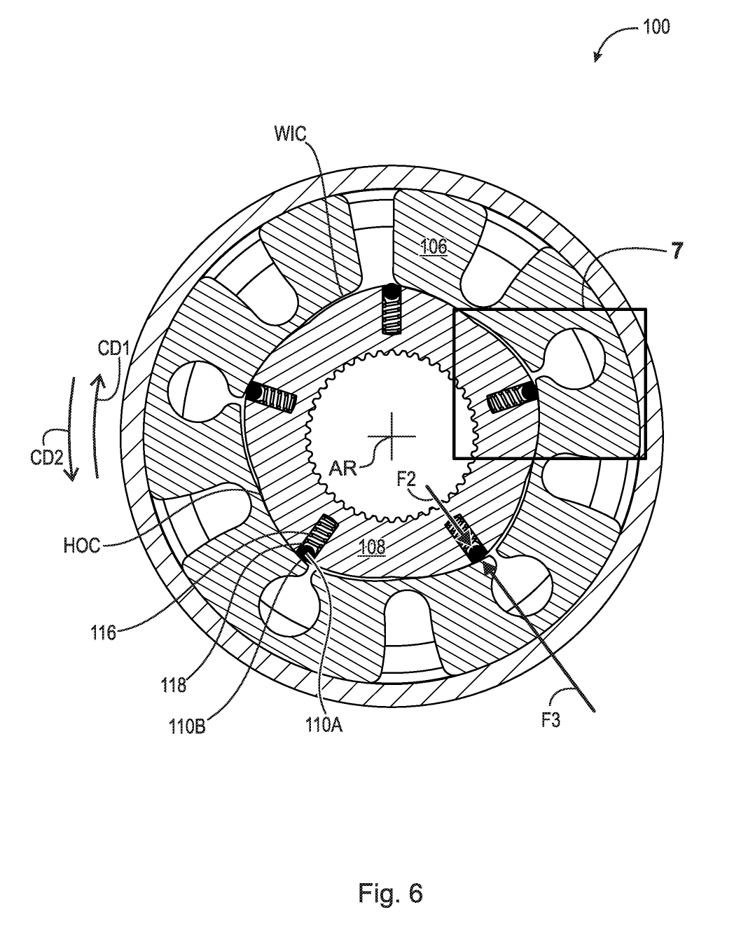

FIG. 6 is a front view of wedge clutch 100 in FIG. 3 in a second synchronization stage. For the second synchronization stage for engaging wedge clutch 100: hub 108 and wedge clutch plates 106 are arranged to circumferentially displace with respect to each other; and wedge clutch plates 106 are arranged to displace pin 110A radially inward. Wedge clutch plates 106 are arranged to displace pin contact portions 110B radially inward so that: at least respective segments of contact portions 110B are radially inward of inner circumference WIC of plates 106 or respective entireties of pins 110A are radially inward of inner circumference WIC. The two possibilities are further discussed below.

As further described below, for the first synchronization stage, a magnitude of torque transmitted between hub 108 and outer carrier 102 is less than a magnitude of torque transmitted between hub 108 and outer carrier 102 in the second synchronization stage. Again as further described below, for the second synchronization stage, wedge clutch plate 106 is arranged to transmit torque between hub 108 and outer carrier 102, and the torque by-passes clutch plates 104.

Pin assembly 110 includes resilient elements 116 urging pins 110A radially outward with respect to hub 108 with force F2. For the second synchronization stage, wedge clutch plates 106 exert force F3 radially inward on pin 110A and greater than force F2. That is, force F3 overcomes force F2 to push pins 110A radially inward. In the examples of FIGS. 3-9, elements 116 are coil springs and pins 110A include retainer sections 110C into which elements 116 are disposed. Resilient elements 116 can be any resilient elements known in the art.

Hub 108 includes slots 118 axially aligned in outer circumference HOC. Respective resilient elements 116 and at least portions of respective pins 110A, for example, contact portions 110B are disposed in the slots. Wedge clutch plates 106 include respective notches 120 in inner circumference WIC of the wedge clutch plates. Inner circumference WIC is the circumference of a non-circular central opening 107 in wedge clutch plate 106. In the first synchronization stage, contact portions 110B are disposed in notches 120. In the second synchronization stage, at least respective segments of contact portions 110B, are disposed in slots 118 and out of notches 120. In the case in which contact portions 110B are displaced completely radially inward of circumference WIC in the second synchronization stage, contact portions 110B are no longer in notches 120. Note that axial length L of pins 110A is sufficient for pins 110A to engage every wedge plate 106 when clutch 100 includes multiple plates 106.

Carrier 102 includes slots 124 in inner circumference CIC of the carrier. Clutch plate 104 includes radially-extending protrusions 128 at least partially disposed in carrier slots 124. The engagement of protrusions 128 and slots 124 non-rotatably connects carrier 102 and plate 104. Thus, plate 104 is not rotatably displaceable with respect to carrier 102, but plate 104 is axially displaceable with respect to carrier 102.

In an example embodiment, carrier 102 includes circumferentially-extending slots 130 in inner circumference CIC and wedge clutch plate 106 includes respective chamfered outer circumference WOC at least partially disposed in slots 130. As previously discussed, wedge clutch plate 106 includes circumferentially disposed and radially-extending ramps 132 on inner circumference WIC. Hub 108 includes circumferentially disposed and radially-extending ramps 134 formed on outer circumference HOC. In an example embodiment, radially-extending ramps 134 are in contact with circumferentially disposed and radially-extending ramps 132. To translate from the first synchronization stage to the second synchronization stage, ramps 132 and 134 are arranged to circumferentially move over each other to expand wedge clutch plate 106 radially outward.

Clutch 100 may include friction material 136 fixed to clutch plate 104 or wedge plate 106, as shown in FIG. 2. For the first synchronization stage, actuator 114 is arranged to frictionally engage clutch plate 104, and wedge plate 106 through, friction material 136. Friction material 136 can be any friction material known in the art.

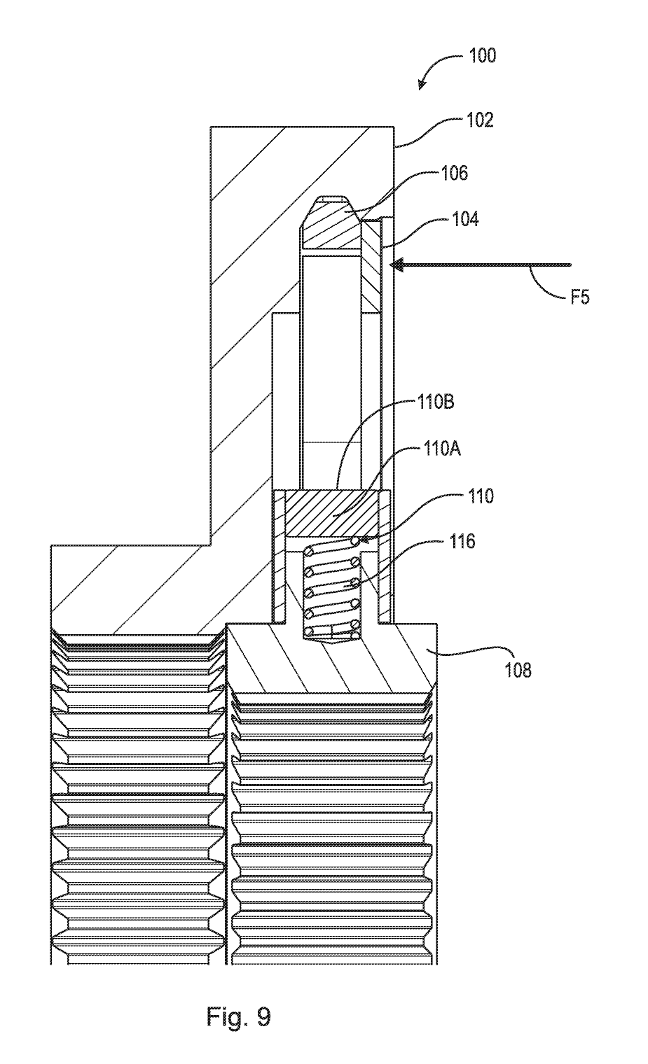

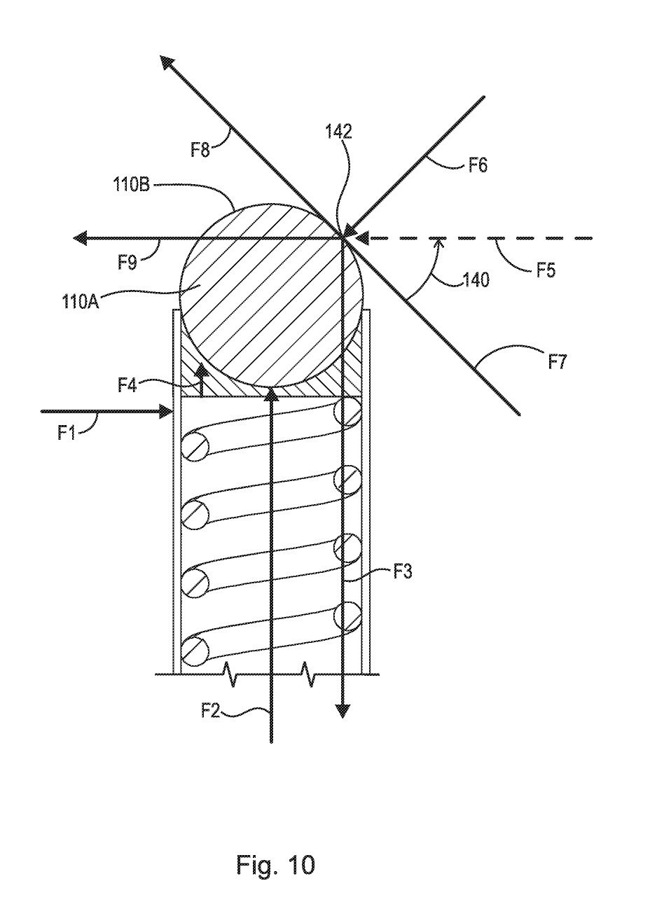

FIG. 10 is a diagram illustrating forces acting on a cylindrical radial torsion pin 110A shown in FIG. 3. In the example of FIG. 10, the hub is receiving torque for transmission to carrier 102, which results in force F1. Resilient element 116 generates force F2, biasing pin 110A outward toward wedge clutch plate 106. Force F4 is friction force resulting from force F1. Force F3 is the vertical force resulting from force F5, which results from torque on the wedge plate. F5 is force that may be received from plate 104. Force F6 is the vertical component of force F5, which results from force F5 being at acute angle 140 with respect to face 142 of pin 110A. Force F7 is the tangential part of force F5, again resulting from angle 140. F8 is the friction resulting from force F6. Force F9 is the horizontal force on hub 108. In the example of FIG. 9, the trigger point (switching from first to second synchronization stage) can be set by selecting elements 116 to provide a particular force F2 and by selecting angle 140 to provide a particular force F3. For example, decreasing angle 140 will reduce the amount of force F5 needed to overcome force F2.

Although coil springs and wave springs are shown in the examples of the present disclosure, it should be understood that other types of resilient elements, including but not limited to, leaf springs and solid pieces of resilient material such as rubber, can be used.

The following provides further detail regarding operation of clutch 100. The discussion that follows is directed to hub 108 receiving torque and hub 108 transmitting the torque to carrier 102 when clutch 100 is engaged. However, it should be understood that the discussion is applicable to the case in which carrier 102 receives torque for transmission to hub 108. Advantageously, there is little or no frictional contact between plates 106 and carrier 102 when clutch 100 is disengaged. Thus, there is little or no drag friction and subsequent losses in efficiency. However, a mechanism is required to implement the engaging and disengaging of clutch 100. This mechanism is centered around pins 110A.

As noted above, to initiate engaging of clutch 100 (first synchronizing stage), actuator 114 clamps plates 104 and 106 so that plates 104 and 106 are frictionally engaged and generally rotate in unison (some slipping is possible) to transmit torque from hub 108 to carrier 102. During the first stage, pins 110A are disposed in notches 120 of wedge plates 106, non-rotatably connecting hub 108 to wedge plates 106. Thus, ramps 132 and 134 do not slide across each other and wedge plates 106 do not expand radially outward. Pins 110A are urged radially outward into notches 120 by resilient elements 116 with force F2. As long as F2 is greater than force F3 generated by the interaction of wedge plates 106 with pins 110A, pins non-rotatably connect hub 108 and plates 106.

However, as torque from hub 108 increases, force F3, from force F5, equals and then surpasses force F2 and hub 108 begins to rotate with respect to plates 106 (force F5 essentially blocks rotation of plates 106) and plates 106 push pins 110A radially inward. As hub 108 begins to rotate with respect to plates 106, ramps 134 begin to slide on ramps 132. In the present example, hub 108 is rotating and transmitting torque in direction CD1. Ramps 132 extend radially inward in direction CD2 and ramps 134 extend radially outward in direction CD1. Thus, as hub 108 rotates in direction CD1 with respect to plates 106 due to force F5, the radially outward portions of ramps 134 slide along the radially inward portions of ramps 132, thus expanding wedge plates 106 radially outward.

When plates 106 are sufficiently radially expanded, plates 106 non-rotatably connect to hub 108 and carrier 104. At this point, the clamping of plates 104 and 106 is no longer needed and actuator 114 can be de-activated, reducing the energy requirements for clutch 100. The particular configuration of ramps 132 and 134 determines the extent to which pins 110A are displaced radially inward. For example, the relative slope of ramps 132 and 134 can be such that the required rotation of hub 108 with respect to plates 106 causes plates 106 to displace all of contact portions 110B radially inward of WIC for plates 106. For example, the relative slope of ramps 132 and 134 can be such that the required rotation of hub 108 with respect to plates 106 is less than the amount needed for plates 106 to displace all of contact portions 110B radially inward of WIC for plates 106.

Advantageously, clutch 100 may use a single actuator in comparison to the two actuators often needed for prior art clutches. Thus, the cost, complexity, size, and energy requirements for clutch 100 are less than those of such prior art clutches. Further, the operation of clutch 100 is simpler and more reliable. Further, mechanical resilient elements 116 are more robust and reliable than a second electric, hydraulic or pneumatic actuator needed for such prior art clutches.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE CHARACTERS

10 cylindrical coordinate system

11 longitudinal axis

12 object illustrating an axial surface

13 object illustrating a radial surface

14 object illustrating a cylindrical surface

15 axial surface of object 12

16 radial surface of object 13

17 radius

18 cylindrical/circumferential surface of object 14

19 circumference passing through surface 18

AD axial direction

CD circumferential direction

R radius

RD radial direction

100 wedge clutch

102 outer carrier

104 clutch plate

107 non-circular wedge clutch plate central opening

106 wedge clutch plate

108 hub

110 pin assembly

110A pin

110B contact portion of pin 110A extending beyond HOC

110C spring retainer section

114 actuator

116 resilient element

118 hub slots

120 wedge clutch plate notches

124 carrier slots

128 clutch plate protrusions

130 circumferential carrier slots

132 radially extending wedge clutch plate ramps

134 radially extending hub ramps

136 friction material on 104 and/or 106

140 acute angle

142 face of pin 110A

AR axis of rotation

C wedge plate central portion

CD1 circumferential hub direction

CD2 circumferential hub direction opposite CD1

CIC inner circumference of carrier 102

F1 force from carrier 102

F2 outward force from 116

F3 inward pin force from wedge plate 106

F4 friction force from F1

F5 force from plate 104

HOC hub outer circumference

L axial length of pin 110A

PIC plate 104 inner surface

WIC wedge plate 106 inner circumference

WOC chamfered outer circumference of wedge plate 106

210 prior art wedge clutch

212 carrier

214 clutch plates

216 wedge clutch plates

218 hub

220 pins

220A portion of 220

220B portion of 220

222 plate

224 plate

226 pass through openings

228 opening

230 opening

232 protrusions

234 slots in in carrier 212

236 ramps on plates 216

238 ramps on hub 218

What is claimed is:

1. A wedge clutch, rotatable about an axis of rotation, comprising:
an outer carrier;
a clutch plate non-rotatably connected to the outer carrier;
a single wedge clutch plate;
a hub radially inward of the outer carrier;
an engagement assembly including at least one cylindrical pin oriented parallel to the axis of rotation, said pin being at least partially disposed within the hub and being radially movable so that a contact portion of the pin can move into and away from contact with the wedge clutch plate; and, for a first synchronization stage arranged for engaging the wedge clutch where the clutch plate and the wedge clutch plate are clamped, and the contact portion of the pin is biased outwardly beyond an outer circumference of the hub to contact the wedge plate to transmit torque between the hub and the carrier; and, for a second synchronization stage, arranged for engaging the wedge clutch: the hub and the wedge clutch plate are arranged to move with respect to each other; and, the wedge clutch plate is arranged to displace the pin radially inward.

2. The wedge clutch of claim 1 where a single actuator is provided to clamp the first clutch plate with the wedge clutch plate.

3. The wedge clutch of claim 1 where the pin is a circular cylinder.

4. The wedge clutch of claim 1, where, in the first synchronization stage, force is transmitted between the hub and the carrier in a circumferential direction through the clutch plate through the contact portion of the pin.

5. The wedge clutch of claim 1, where, for the second synchronization stage, the wedge clutch plate is arranged to displace the contact portion of the pin radially inward so that at least a sufficient segment of the contact portion is radially inward of the inner circumference of the wedge clutch plate to avoid interference with clutch plate rotation.

6. The wedge clutch of claim 1, where, in the first synchronization stage, a magnitude of first torque transmitted between the hub and the carrier is less than a magnitude of second torque transmitted between the hub and the carrier in the second synchronization stage.

7. The wedge clutch of claim 1, where, in the second synchronization stage, the wedge clutch plate is arranged to transmit torque between the hub and the carrier and the torque by-passes the first clutch plate.

8. The wedge clutch of claim 1, where the engagement assembly includes a resilient element urging the pin radially outward with respect to the hub with a first force and in the second synchronization stage, the wedge clutch plate exerts a second force radially inward on the pin and greater than the first force.

9. The wedge clutch of claim 8, where the hub includes at least one slot, axially aligned, in the outer circumference of the hub; the resilient element and a second portion of the pin are disposed in the slot; the wedge clutch plate includes a notch in an inner circumference of the wedge clutch plate; in the first synchronization stage, the contact portion of the pin is disposed in the notch; and, in the second synchronization stage, the contact portion of the pin is out of the slot and at least a segment of the contact portion of the pin is disposed in the slot.

10. The wedge clutch of claim 9, where the carrier includes a plurality of slots in an inner circumference of the carrier; and, the first clutch plate includes a plurality of radially-extending protrusions at least partially disposed in the plurality of slots.

11. The wedge clutch of claim 1, where:
the carrier includes a circumferentially-extending slot in an inner circumference of the carrier; the wedge clutch plate includes a chamfered outer circumference at least partially disposed in the slot; and, a first plurality of circumferentially disposed and radially-extending ramps formed on an inner circumference of the wedge clutch plate; and, the hub includes a second plurality of circumferentially disposed and radially-extending ramps formed on the outer circumference of the hub in contact with the first plurality of circumferentially disposed and radially-extending ramps; and, to translate from the first synchronization stage to the second synchronization stage the first and second pluralities of circumferentially disposed and radially-extending ramps are arranged to engage with respect to each other to expand the wedge clutch plate radially outward.

12. The wedge clutch of claim 1, further comprising friction material fixed to at least one of the first clutch plate and the wedge clutch plate; and, in the first synchronization stage, the actuator is arranged to frictionally engage the first clutch plate and the wedge clutch plate through the friction material.

13. The wedge clutch of claim 1, where, in the second synchronization stage, the first clutch plate and the wedge clutch plate are not frictionally engaged.

14. The wedge clutch of claim 1, where the wedge clutch is free of an actuator arranged to directly apply a radial force to the pin or to apply a circumferential or radial force to the wedge clutch plate.

15. A wedge clutch rotatable about an axis of rotation, comprising:
an outer carrier;
a first clutch plate non-rotatably connected to the outer carrier;
a wedge clutch plate radially inward of the outer carrier;
a hub radially inward of the outer carrier; and,
an engagement assembly including:
a cylindrical pin non-rotatably connected to the hub and engageable with the wedge clutch plate, where the pin has a circular shape in a cross-section formed by a plane orthogonal to the axis of rotation; and, a single actuator arranged for engaging the wedge clutch and clamping the first clutch plate and the wedge clutch plate, in a first synchronization stage, where, during the first synchronization stage the clutch plate and wedge clutch plate are clamped and the pin is arranged to non-rotatably connect the hub and the wedge clutch plate; and, during a second synchronization stage for engaging the wedge clutch, the wedge clutch plate is arranged to apply a first force urging the pin radially inward.

16. The wedge clutch of claim 15, where in the second synchronization stage the wedge clutch plate is arranged to circumferentially displace with respect to the hub to apply the first force; and, the wedge clutch plate is arranged to expand radially outward to non-rotatably connect to the hub and the carrier.

17. The wedge clutch of claim 16, comprising:
a slot in the hub axially aligned, in the outer circumference of the hub,
a resilient element in the engagement assembly disposed in the slot and urging the pin radially outward;
a notch in an inner circumference of the wedge clutch plate; and,
a portion of the pin disposed in the notch during the first synchronization stage.

18. The wedge clutch of claim 17, where during the first synchronization stage either:
the hub is arranged to transmit force, in a circumferential direction, to the wedge clutch plate through a portion of the pin radially outward of an outer circumference for the hub; or,
the wedge clutch plate is arranged to transmit force, in a circumferential direction, to the hub through a portion of the pin radially outward of an outer circumference of the hub.
